(19) United States
(12) Patent Application Publication
(10) Pub. No.: US 2012/0306428 A1
(43) Pub. Date: Dec. 6, 2012

(54) STEPPING MOTOR CONTROL CIRCUIT AND ANALOG ELECTRONIC TIMEPIECE

(76) Inventors: Saburo MANAKA, Chiba-shi (JP); Kenji Ogasawara, Chiba-shi (JP); Kazumi Sakumoto, Chiba-shi (JP); Keishi Honmura, Chiba-shi (JP); Hiroshi Shimizu, Chiba-shi (JP); Kosuke Yamamoto, Chiba-shi (JP)

(21) Appl. No.: 13/479,799

(22) Filed: May 24, 2012

(30) Foreign Application Priority Data
Jun. 1, 2011 (JP) 2011-123327
Mar. 16, 2012 (JP) 2012-060966

(51) Int. Cl. H02P 8/00

(52) U.S. Cl. 318/685

(57) ABSTRACT

A control unit is provided which drives a stepping motor in a first mode in which a driving pulse is selected between one kind of main driving pulse and a correction driving pulse with energy greater than the one kind of main driving pulse in accordance with a rotation state of the stepping motor and the stepping motor is driven or a second mode in which the driving pulse is selected among plural kinds of main driving pulses and a correction driving pulse with energy greater than the plural kinds of main driving pulses in accordance with the rotation state of the stepping motor and the stepping motor is driven. The control unit switches a mode between the first and second modes depending on whether the voltage of a secondary cell serving as a power supply exceeds a switch voltage and drives the stepping motor.

### BACKGROUND OF THE INVENTION

1. Field of the Invention

The present invention relates to a stepping motor control circuit using a secondary cell as a power supply and an analog electronic timepiece using the stepping motor control circuit.

2. Background Art

Hitherto, analog electronic timepieces have been developed which use as a power supply a secondary cell charged by power generation means such as a solar cell.

In the analog electronic timepieces including the power generation means according to the related art, plural kinds of main driving pulses P1 different from each other in energy are provided and a main driving pulse P1 is switched to a main driving pulse P1 with larger energy in accordance with the voltage of the secondary cell (pulse-increase) to drive a stepping motor (for example, see JP-A-62-238484).

Thus, when the main driving pulse P1 is switched to the main driving pulse P1 with the energy corresponding to the voltage of the secondary cell to drive the stepping motor, the stepping motor can be rotated even in a case where the voltage of the secondary cell is lowered.

However, only when the main driving pulse P1 is switched to the main driving pulse P1 in accordance with the voltage of the secondary cell, a problem may arise in that the energy of the secondary cell is consumed dramatically. This is because when the stepping motor may not be rotated by the main driving pulse P1, the stepping motor has to be driven by a correction driving pulse P2 having larger energy than the main driving pulse P1.

On the other hand, there is the known invention in which a plurality of main driving pulses P1 are provided and a main driving pulse P1 is switched (pulse-increase) quickly to a main driving pulse P1 with larger energy to drive a stepping motor, as the energy used to drive the stepping motor becomes barely sufficient for driving the stepping motor and thus the driving margin is decreased. By combining this invention and the invention disclosed in JP-A-62-238484, the main driving pulse can be switched in accordance with the voltage of the secondary cell and a main driving pulse can be switched to a main driving pulse with the margin of energy depending on a rotation situation of the stepping motor and the stepping motor is driven.

However, since the main driving pulse is pulse-increased quickly irrespective of a case in which the stepping motor can be driven, a problem may arise in that the driving energy is unnecessarily consumed.

### SUMMARY OF THE INVENTION

It is an aspect of the present application to provide a technique of suppressing energy consumption, while non-rotation is prevented by driving a stepping motor by a main driving pulse in accordance with the voltage of a secondary cell and a rotation state of the stepping motor.

According to another aspect of the application, there is provided a stepping motor control circuit including: a secondary cell serving as a power supply that supplies power at least to a stepping motor; a voltage detection unit detecting a voltage of the secondary cell; a rotation detection unit detecting a rotation state of the stepping motor; and a control unit driving the stepping motor in a first mode in which a driving pulse is selected between one kind of main driving pulse and a correction driving pulse with energy greater than the one kind of main driving pulse in accordance with a rotation state of the stepping motor and the stepping motor is driven or a second mode in which the driving pulse is selected among plural kinds of main driving pulses and a correction driving pulse with energy greater than the plural kinds of main driving pulses in accordance with the rotation state of the stepping motor and the stepping motor is driven. The control unit switches a mode between the first and second modes depending on whether the voltage of the secondary cell detected by the voltage detection unit exceeds a predetermined switch voltage and drives the stepping motor.

According to another aspect of the application, there is provided an analog electronic timepiece including: a stepping motor rotatably driving a time pointer; and a stepping motor control circuit controlling the stepping motor. The stepping motor control circuit described above serves as the stepping motor control circuit.

In the stepping motor control circuit according to the application, energy consumption can be suppressed, while non-rotation is prevented by driving the stepping motor by a main driving pulse in accordance with the voltage of a secondary cell and a rotation state of the stepping motor.

Further, in the analog electronic timepiece according to the application, energy consumption can be suppressed, while non-rotation is prevented by driving the stepping motor by a main driving pulse in accordance with the voltage of a secondary cell and a rotation state of the stepping motor. Therefore, it is possible to obtain the advantage of performing accurate pointer movement, etc.

### BRIEF DESCRIPTION OF THE DRAWINGS

FIG. 1 is a common block diagram illustrating an analog electronic timepiece that uses a stepping motor control circuit according to each embodiment of the invention.

FIG. 2 is a common diagram illustrating timings of the stepping motor control circuit and the analog electronic timepiece according to each embodiment of the invention.

FIG. 3 is a diagram illustrating a common determination chart of the stepping motor control circuit and the analog electronic timepiece according to each embodiment of the invention.

FIG. 4 is a flowchart illustrating a stepping motor control circuit and an analog electronic timepiece according to a first embodiment of the invention.

FIG. 5 is a flowchart illustrating a stepping motor control circuit and an analog electronic timepiece according to a second embodiment of the invention.

FIG. 6 is a common diagram illustrating timings of a stepping motor control circuit and an analog electronic timepiece according to a third embodiment of the invention.

FIG. 7 is a diagram illustrating a common determination chart of the stepping motor control circuit and the analog electronic timepiece according to the third embodiment of the invention.

FIG. 8 is a flowchart illustrating the stepping motor control circuit and the analog electronic timepiece according to the third embodiment of the invention.

### DETAILED DESCRIPTION OF THE INVENTION

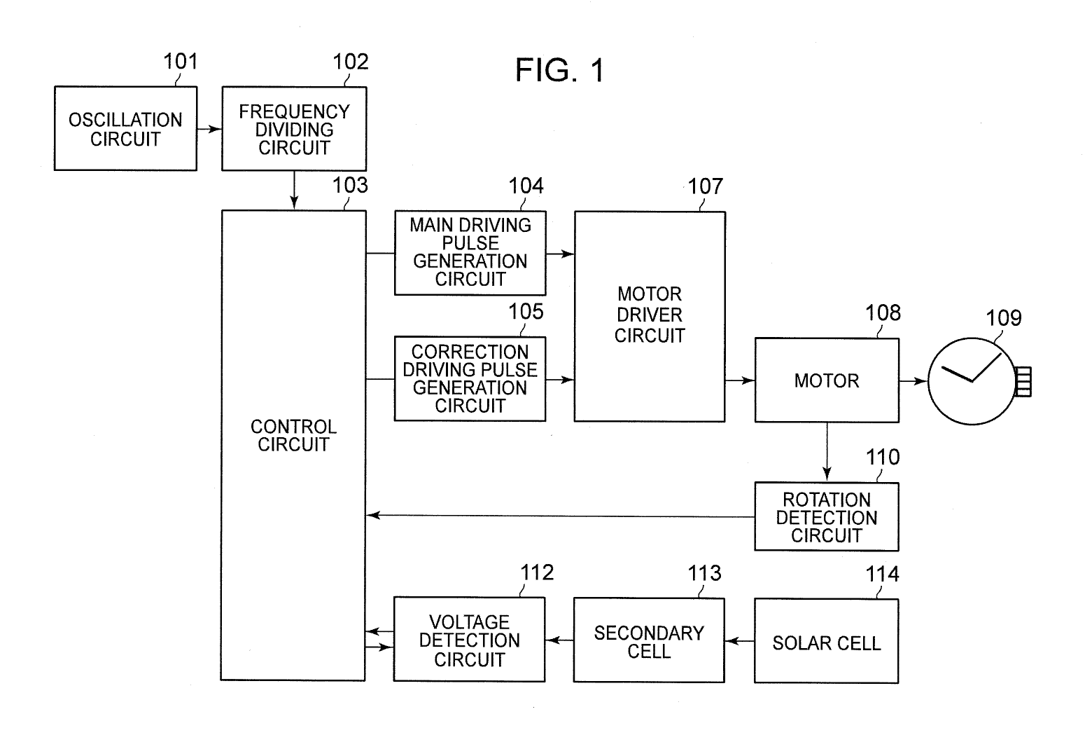

FIG. 1 is a common block diagram illustrating an analog electronic timepiece that uses a stepping motor control circuit according to each embodiment of the invention described below. An example of an analog electronic wristwatch is illustrated.

In FIG. 1, the analog electronic timepiece includes an oscillation circuit 101 that generates a signal with a predetermined frequency; a frequency dividing circuit 102 that divides the signal generated by the oscillation circuit 101 and generates a timepiece signal serving as a reference of time measurement; and a control circuit 103 that performs a time measurement process of the timepiece signal or various kinds of control such as control of each electronic circuit element of the analog electronic timepiece and change control of a driving pulse.

The analog electronic timepiece further includes a main driving pulse generation circuit 104 that selects and outputs a main driving pulse among plural kinds of main driving pulses P1 different from each other in energy based on a main driving pulse control signal from the control circuit 103; and a correction driving pulse generation circuit 105 that outputs a correction driving pulse P2 with an energy greater than each of the main driving pulses P1 based on a correction driving pulse control signal from the control circuit 103.

The analog electronic timepiece further includes a motor driver circuit 107 that rotatably drives the stepping motor 108 in response to the main driving pulses P1 from the main driving pulse generation circuit 104 and the correction driving pulse P2 from the correction driving pulse generation circuit 105.

The analog electronic timepiece further includes a stepping motor 108 that is rotatably driven by the motor driver circuit 107; and an analog display unit 109 that includes a display unit, etc. displaying time pointers for time display or a calendar rotatably driven by the stepping motor 108.

The analog electronic timepiece further includes a rotation detection circuit 110 that detects an induction signal VRs generated by the rotation of the stepping motor 108 and indicating a rotation state in a predetermined rotation detection section; and a detection section determination circuit 111 that determines a section in which the induction signal VRs is detected by comparing a time, at which the rotation detection circuit 110 detects the induction signal VRs exceeding a predetermined reference threshold voltage Vcomp, to the detected section.

As a control mode in which the control circuit 103 rotatably controls the stepping motor 108, there are provided two kinds of modes: first and second modes.

The first mode is a mode in which the stepping motor 108 is rotatably driven by one kind of main driving pulse P1 and a rotation state is determined using the entire detection section T as one section. It is determined that the stepping motor 108 is rotated, when the rotation detection circuit 110 detects the induction signal VRs exceeding the predetermined reference threshold voltage Vcomp in the entire detection section T used as one section. Conversely, it is determined that the stepping motor 108 is not rotated, when the rotation detection circuit 110 does not detect the induction signal VRs. When the stepping motor 108 is not rotated within this section, the stepping motor 108 is driven to be rotated forcibly with the correction driving pulse P2.

The second mode is a mode in which the stepping motor 108 is rotatably driven using the plural kinds of main driving pulses P1 and a rotation state is determined by dividing the detection section T into a plurality of sections (three sections in the embodiments of the invention) and using the divided sections. Further, the second mode is a mode quickly performing pulse control in which when it is detected that the stepping motor 108 is barely rotated (that the stepping motor 108 can be rotated but there is no margin of energy), the main driving pulse P1 is pulse-increased before the stepping motor 108 is not rotated.

In the second mode, the detection period T is divided into a plurality of sections, the rotation state of the stepping motor 108 is determined based on the generation state (a pattern of the induction signal VRs) of the induction signal VRs in each section, and a driving pulse is selected in accordance with the rotation state to drive the stepping motor 108. In the second mode, the detection section determination circuit 111 determines a section to which the induction signal VRs exceeding the reference threshold voltage Vcomp detected by the rotation detection circuit 110 belongs. In this case, the control circuit 103 determines a rotation state based on the pattern of the section in which the induction signal VRs exceeding the reference threshold voltage Vcomp is generated and performs the pulse control such as pulse-increase or pulse-decrease of the main driving pulse P1.

The analog electronic timepiece further includes a secondary cell 113 serving as a power supply supplying power to the stepping motor 108 and each electronic circuit element of the analog electronic timepiece, a solar cell 114 that charges the secondary cell 113, and a voltage detection circuit 112 that detects the voltage of the secondary cell 113. The secondary cell 113 functions as the power supply supplying the power to at least the stepping motor 108.

The oscillation circuit 101 and the frequency dividing circuit 102 form a signal generation unit. The analog display unit 109 forms an announcement unit. The rotation detection circuit 110 and the detection section determination circuit 111 form a rotation detection unit. The solar cell 114 forms a power generation unit for generating power and also forms a charging unit for charging the secondary cell 113. The main driving pulse generation circuit 104 and the correction driving pulse generation circuit 105 form a driving pulse generation unit. The oscillation circuit 101, the frequency dividing circuit 102, the control circuit 103, the main driving pulse generation circuit 104, the correction driving pulse generation circuit 105, and the motor driver circuit 107 form a control unit.

The solar cell 114 generates power to charge the secondary cell 113. The secondary cell 113 serving as the power supply supplies the power to the stepping motor 108 and the circuit elements of the analog electronic timepiece, so that the analog electronic timepiece operates.

A time display process in a normal operation will be described in brief in FIG. 1. The oscillation circuit 101 generates a signal with a predetermined frequency and the frequency dividing circuit 102 divides the signal generated by the oscillation circuit 101, generates a timepiece signal (for example, a signal with a period of 1 second) serving as a reference of the time measurement, and outputs the timepiece signal to the control circuit 103.

The control circuit 103 performs a time measurement process based on the timepiece signal and outputs a main driving pulse control signal to the main driving pulse generation circuit 104, so that the stepping motor 108 can be rotatably driven in a predetermined period by the driving pulse corresponding to the magnitude of a load or the voltage of the secondary cell 113.

In the embodiment of the invention, plural kinds of driving pulses are provided as the driving pulse used to rotatably rotate the stepping motor 108. The plural kinds (that is, plural ranks) of main driving pulses P1 different from each other in energy and a correction driving pulse P2 with energy larger than each main driving pulse P1 are used as the driving pulse.

The main driving pulse P1 is a driving pulse used to rotatably drive the stepping motor 108 when time pointers (second, minute, and hour pointers) are normally moved. The correction driving pulse P2 is a driving pulse used to forcibly rotate the stepping motor 108 when the stepping motor 108 may not be rotated by the main driving pulse P1.

The main driving pulse generation circuit 104 outputs, to the motor driver circuit 107, the main driving pulse P1 with the energy rank corresponding to the main driving pulse control signal from the control circuit 103. The motor driver circuit 107 rotatably drives the stepping motor 108 by the main driving pulses P1. The stepping motor 108 is rotatably driven by the main driving pulses P1, so that the stepping motor 108 rotatably drives the time pointers of the analog display unit 109. Thus, when the stepping motor 108 is normally rotated, the current time is displayed by the time pointers in the analog display unit 109.

The rotation detection circuit 110 detects a detection signal VRs exceeding a predetermined reference threshold voltage Vcomp among the induction signals VRs generated by rotation free oscillation of the stepping motor 108 in a predetermined detection section T.

The rotation detection circuit 110 is configured to detect the detection signal VRs exceeding the predetermined reference threshold voltage Vcomp, when a rotor (not shown) of the stepping motor 108 performs a constant fast operation, for example, when the stepping motor 108 is rotated. On the other hand, the reference threshold voltage Vcomp is set so that the detection signal VRs does not exceed the reference threshold voltage Vcomp, when the rotor does not perform a constant fast operation, for example, when the stepping motor 108 is not rotated.

When the control mode is the first mode, the detection section determination circuit 111 does not perform the determination of the section. Therefore, the detection result of the rotation detection circuit 110 is directly input into the control circuit 103.

When the rotation detection circuit 110 detects the induction signal VRs exceeding the reference threshold voltage Vcomp in the detection section, the control circuit 103 determines that the stepping motor 108 is rotated. Conversely, when the rotation detection circuit 110 does not detect the induction signal VRs exceeding the reference threshold voltage Vcomp in the detection section, the control circuit 103 determines that the stepping motor 108 is not rotated, and thus forcibly rotatably drive the stepping motor 108 by the correction driving pulse P2.

When the control mode is the second mode, the detection section determination circuit 111 compares the detection time of the induction signal VRs exceeding the reference threshold voltage Vcomp detected by the rotation detection circuit 110 to the detected section, and then determines a section in which the induction signal VRs is detected. The control circuit 103 determines the rotation state of the stepping motor 108 based on the pattern of the induction signal VRs determined by the detection section determination circuit 111 and determines the margin of the energy of the main driving pulse P1 used to drive the stepping motor 108.

Based on the pattern of the induction signal VRs, the control circuit 103 performs pulse control by outputting the control signal to the main driving pulse generation circuit 104 so that the energy of the main driving pulse P1 increases by one rank (pulse-increase) or the energy of the main driving pulse P1 decreases by one rank (pulse-decrease) or performs pulse control by outputting a control signal to the correction driving pulse generation circuit 105 so that the stepping motor 108 is driven by the correction driving pulse P2.

The main driving pulse generation circuit 104 or the correction driving pulse generation circuit 105 outputs a driving pulse to the motor driver circuit 107 in accordance with the control signal. Then, the motor driver circuit 107 rotatably drives the stepping motor 108 by the driving pulse.

The control circuit 103 switches the control mode between the first and second modes in accordance with the voltage of the secondary cell 113. That is, the control circuit 103 switches the control mode between the first and second modes, when the voltage of the secondary cell 113 detected by the voltage detection circuit 112 reaches a current switch voltage which is a predetermined voltage. In this embodiment, a first reference voltage Lo which is a predetermined low voltage and a second reference voltage Hi higher than the first reference voltage Lo are used as the switch voltages. The switch voltage is switched depending on the rotation state of the stepping motor 108.

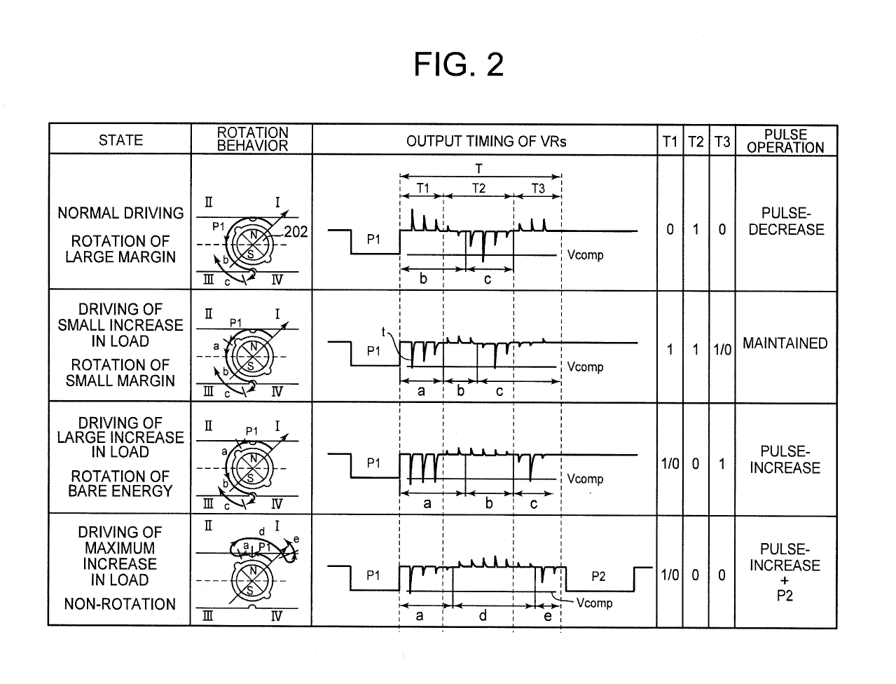

FIG. 2 is a diagram illustrating timings when the stepping motor 108 is driven by the main driving pulse P1 in the second mode according to the embodiment of the invention. FIG. 2 shows the degree of margin of the driving pulse, the rotational position of a rotor 202 of the stepping motor 108, the pattern of the induction signal VRs indicating the rotation state, and a pulse control operation.

In FIG. 2, P1 denotes the main driving pulse P1 and also indicates a region in which the rotor 202 of the stepping motor 108 is rotatably driven by the main driving pulse P1 and a to e denote regions of the rotation position of the rotor 202 by the free oscillation after the stop of the driving by the main driving pulse P1.

A predetermined time immediately after the driving by the main driving pulse P1 is set to a first section T1, a predetermined time after the first section T1 is set to a second section T2, and a predetermined time after the second section T2 is set to a third section T3. Thus, the entire detection section T starting immediately after the driving by the main driving pulse P1 is divided into the plurality of sections (in this embodiment, three sections T1 to T3). In this embodiment, a mask section, which is a section in which no induction signal VRs is detected, is not provided.

When the XY coordinate space, where the rotor 202 is a center and a main magnetic pole (the straight arrow in the drawings indicating the rotation behavior in FIG. 2) of the rotor 202 is located by the rotation, is divided into the first quadrant I to the fourth quadrant IV, the first section T1 to the third section T3 can be expressed as follows.

That is, in a normal driving state (a rotation state where the margin of the driving energy is large), the first section T1 is a section in which a forward direction (counterclockwise rotation direction) rotation state of the rotor 202 in the third quadrant III of the space where the rotor 202 is the center is determined, the second section T2 is a section in which the initial forward direction rotation state and the initial backward direction (clockwise direction) rotation state of the rotor 202 in the third quadrant III are determined, and the third section T3 is a section in which the rotation state after the initial backward direction rotation of the rotor 202 in the third quadrant III is determined. Here, the normal driving state is a state where the load driven in the normal time can be driven regularly by the main driving pulse P1. In this embodiment, the normal driving state is a state where the time pointers can be regularly driven as the load by the main driving pulse P1.

In a state (a driving state where an increase in the load is small and a rotation state where the margin of the energy is small) where the driving energy is slightly smaller than the normal driving, the first section T1 is a section in which the forward direction rotation state of the rotor 202 in the second quadrant II is determined, the second section T2 is a section in which the initial forward direction rotation state and the initial backward direction rotation state of the rotor 202 in the third quadrant III are determined, and the third section T3 is a section in which the rotation state after the initial backward direction rotation state of the rotor 202 in the third quadrant III is determined.

In a state (a driving state where the increase in the load is large and a rotation state where the energy is the maximum) where the driving energy is yet smaller than the rotation state where the margin of the energy is small, the first section T1 is a section in which the forward direction rotation state of the rotor 202 in the second quadrant II is determined, the second section T2 is a section in which the forward direction rotation state of the rotor 202 in the second quadrant II and the initial forward direction rotation state of the rotor 202 in the third quadrant III are determined, and the third section T3 is a section in which the rotation state after the initial backward direction rotation state of the rotor 202 in the third quadrant III is determined.

In a state (a driving state where the increase in the load is the maximum and a non-rotation state where the energy is not sufficient) where the driving energy is yet smaller than the rotation state where the energy is the maximum, the rotor 202 may not be rotated.

In FIG. 2, for example, in the normal driving state of the stepping motor control circuit according to this embodiment, the induction signal VRs generated in the region b is detected in the first section T1 and the second section T2 and the induction signal VRs generated in the region c is detected in the second section T2, and the induction signal VRs generated after the region c is detected in the third section T3.

On the assumption that a determination value “1” indicates a case where the rotation detection circuit 110 detects the induction signal VRs exceeding the reference threshold voltage Vcomp and a determination value indicates a case where the rotation detection circuit 110 may not detect the induction signal VRs exceeding the reference threshold voltage Vcomp, (0, 1, 0) is obtained as a pattern (a determination value in the first section, a determination value in the second section, and a determination value of the third section) indicating the rotation state in the normal driving example of FIG. 2. In this case, the control circuit 103 determines that the margin of the driving energy is large, decreases the driving energy by one rank (pulse-decrease), and performs pulse control so that the main driving pulse P1 is changed to the main driving pulse P1 of the driving energy decreased by one rank.

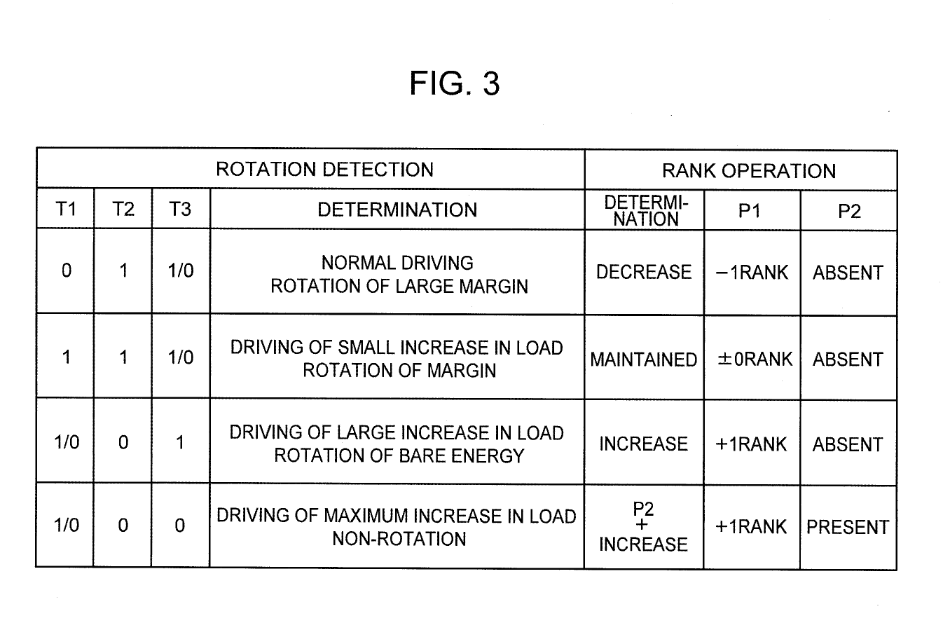

FIG. 3 is a diagram illustrating a common determination chart of the pulse control operations according to each embodiment of the invention. In FIG. 3, as described above, the determination value “1” indicates the case where the induction signal VRs exceeding the reference threshold voltage Vcomp is detected and the determination value “0” indicates the case where the induction signal VRs exceeding the reference threshold voltage Vcomp may not be detected. Further, a determination value “1/0” indicates any one of the determination values “1” and “0”.

As shown in FIG. 3, the rotation detection circuit 110 detects whether the induction signal VRs exceeding the reference threshold voltage Vcomp is present. The detection section determination circuit 111 determines the pattern of the induction signal VRs indicating a section to which the induction signal VRs belongs. The control circuit 103 performs pulse control, such as pulse-increase or pulse-decrease of the main driving pulse P1 or the driving performed by the correction driving pulse P2, described below based on the pattern of the induction signal VRs with reference to the determination chart of FIG. 3 stored in the control circuit 103, and then controls the rotations of the steeping motor 108.

For example, when a pattern is (1/0, 0, 0), the control circuit 103 determines that the stepping motor 108 is not rotated (non-rotation), controls the correction driving pulse generation circuit 105 so that the stepping motor 108 is driven by the correction driving pulse P2, and then controls the main driving pulse generation circuit 104 so that the driving pulse is changed to the main driving pulse P1 with an energy increased by one rank at the subsequent driving time for the driving.

When a pattern is (1/0, 0, 1), the stepping motor 108 is rotated, but the driving energy is considerably low for the load in this state. Therefore, the control circuit 103 determines that there is a concern that the stepping motor may be not rotated at the subsequent driving time, and thus controls the main driving pulse generation circuit 104 so that the stepping motor 108 is not driven by the correction driving pulse P2 and the main driving pulse P1 is switched in advance to the main driving pulse P1 with an energy increased by one rank at the subsequent driving time.

When a pattern is (1, 1, 1/0), the control circuit 103 determines that the stepping motor 108 is rotated and can be rotated at the subsequent driving time in spite of the fact that the margin of the driving energy is small for the load. The control circuit 103 controls the main driving pulse generation circuit 104 such that the main driving pulse generation circuit 104 does not change the main driving pulse P1 at the subsequent driving time for the driving.

When a pattern is (0, 1, 1/0), the control circuit 103 determines that the stepping motor 108 is rotated and the driving energy is excessive for the load. The control circuit 103 controls the main driving pulse generation circuit 104 such that the main driving pulse generation circuit 104 changes the main driving pulse P1 to the main driving pulse P1 with an energy deceased by one rank for the driving.

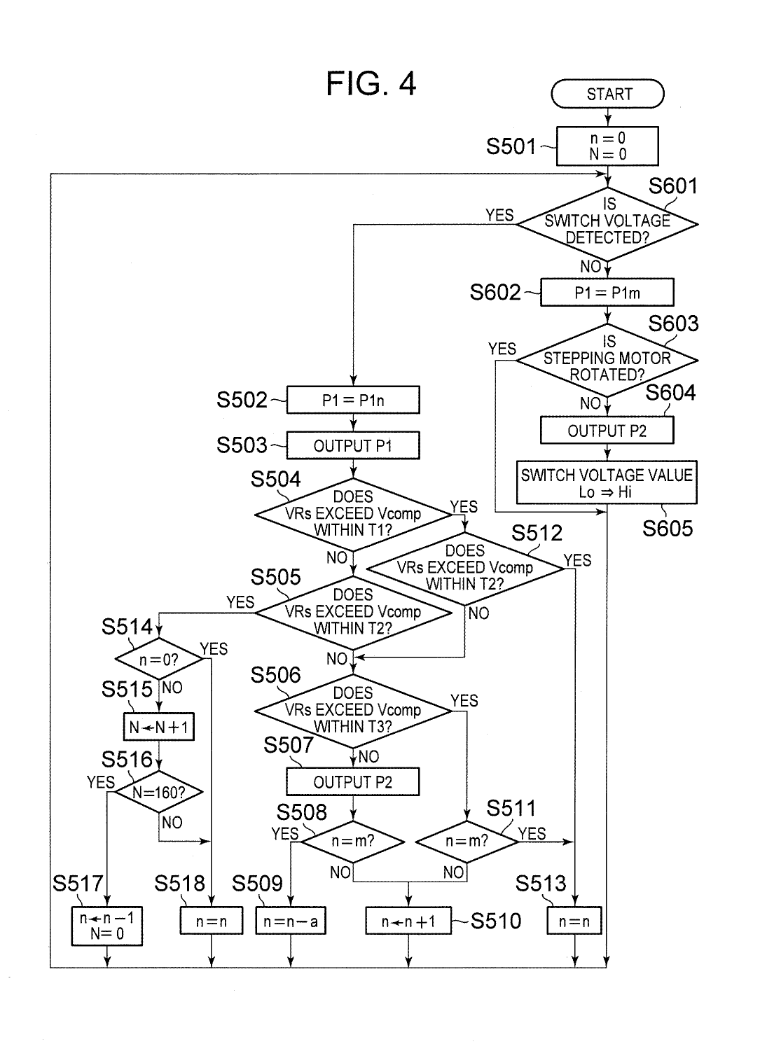

FIG. 4 is a flowchart illustrating the operations of the stepping motor control circuit and the analog electronic timepiece according to a first embodiment of the invention and is a flowchart mainly illustrating an operation of the control circuit 103.

Hereinafter, an operation of the first embodiment of the invention will be described in detail with reference to FIGS. 1 to 4. In the initial state, the first reference voltage Lo of the low level is set as the switch voltage.

The control circuit 103 resets a rank n of the main driving pulse P1 to 0 (main driving pulse P10) with the minimum energy and resets the value of a continuous driving number of times N to 0 (step S501).

Next, the control circuit 103 allows the voltage detection circuit 112 to detect the voltage of the secondary cell 113 and determines whether the voltage detection circuit 112 detects the switch voltage (here, the first reference voltage Lo), that is, whether the voltage of the secondary cell 113 is lowered to a voltage equal to or less than the switch voltage (step S601).

When the control circuit 103 determines that the voltage of the secondary cell 113 exceeds the switch voltage and thus is not lowered to the switch voltage in the process of step S601, the control circuit 103 performs the driving in the first mode.

In the first mode, the control circuit 103 outputs a control signal to the main driving pulse generation circuit 104 so that the main driving pulse P1 is fixed to a main driving pulse P1m with the maximum energy rank among the plural kinds of main driving pulses P1 used in the second mode and the stepping motor 108 is driven (step S602). The main driving pulse generation circuit 104 fixes the main driving pulse P1 to one kind of main driving pulse P1m with the maximum energy in response to the control signal from the control circuit 103, and then the stepping motor 108 is driven by the motor driver circuit 107.

The main driving pulse P1 used in the driving of the first mode is the one kind of main driving pulse P1. Therefore, even when the energy is lowered, the pulse does not quickly increase and the stepping motor 108 is driven as far as possible by the main driving pulse. Accordingly, it is possible to prevent the energy from being unnecessarily consumed.

The main driving pulse P1 used in the driving of the first mode is the one kind of main driving pulse P1m with the maximum energy among the main driving pulses P1 used in the second mode. Therefore, even when the voltage of the secondary cell 113 is lowered, the stepping motor 108 can be rotated more reliably.

When the stepping motor 108 is rotated in the detection section T immediately after the driving of the stepping motor 108, the rotation detection circuit 110 detects the induction signal VRs exceeding the reference threshold voltage Vcomp. When the stepping motor 108 is not rotated, the rotation detection circuit 110 does not detect the induction signal VRs exceeding the reference threshold voltage Vcomp.

Based on the detection result of the rotation detection circuit 110, the control circuit 103 determines whether the stepping motor 108 is rotated (step S603). When the control circuit 103 determines that the stepping motor 108 is rotated, the process returns to step S601.

When the control circuit 103 determines that the stepping motor 108 is not rotated in the process of step S603, the control circuit 103 outputs a control signal to the correction driving pulse generation circuit 105 so that the stepping motor 108 is driven by the correction driving pulse P2 (step S604). In response to the control signal from the control circuit 103, the correction driving pulse generation circuit 105 allows the motor driver circuit 107 to drive the stepping motor 108 by the correction driving pulse P2.

Next, the control circuit 103 switches the switch voltage to the second reference voltage Hi higher than the first reference voltage Lo (step S605). Then, since the level of the switch voltage increases, the reduction of the voltage of the secondary cell 113 up to the switch voltage is quickly detected in the process of step S601. Therefore, the control mode is changed to the second mode, and thus the driving of the stepping motor 108 by the correction driving pulse P2 is avoided in the process of step S604. Accordingly, it is possible to suppress the energy consumption.

Conversely, when the control circuit 103 determines that the voltage of the secondary cell 113 is lowered to the voltage equal to or less than the switch voltage in the process of step S601, the control circuit 103 performs the driving in the second mode.

In the second mode, the control circuit 103 selects a main driving pulse P1n with the energy rank n (here, “0” of the minimum energy rank) (step S502) and outputs a control signal to the main driving pulse generation circuit 104 so that the stepping motor 108 is driven by the main driving pulse Pin (step S503).

The main driving pulse generation circuit 104 outputs the main driving pulse P1n with the energy corresponding to the control signal to the motor driver circuit 107. The motor driver circuit 107 rotatably drives the stepping motor 108 by the main driving pulse P1n.

The rotation detection circuit 110 detects the induction signal VRs exceeding the reference threshold voltage Vcomp among the induction signals VRs generated by the rotation of the stepping motor 108 in the detection section T. The detection section determination circuit 111 determines a section to which the induction signal VRs exceeding the reference threshold voltage Vcomp belongs among the sections T1 to T3.

The control circuit 103 determines whether the detection section determination circuit 111 determines that the detection time t of the induction signal VRs is within the section T1 (that is, whether the induction signal VRs exceeding the reference threshold voltage Vcomp is detected within the first section T1) (step S504).

When the control circuit 103 determines that the induction signal VRs exceeding the reference threshold voltage Vcomp is not detected within the section T1 in the process of step S504 (in a case of the pattern (0, x, x) where a determination value “x” means the determination value is “1” or “0”), the control circuit 103 determines whether the induction signal VRs exceeding the reference threshold voltage Vcomp is detected within the section T2 in the same way (step S505).

When the control circuit 103 determines that the induction signal VRs exceeding the reference threshold voltage Vcomp is not detected within the section T2 in the process of step S505 (in a case of the pattern (0, 0, x)), the control circuit 103 determines whether the induction signal VRs exceeding the reference threshold voltage Vcomp is detected within the section T3 in the same way (step S506).

When the control circuit 103 determines that the induction signal VRs exceeding the reference threshold voltage Vcomp is not detected within the section T3 in the process of step S506 (in a case of the pattern (x, 0, 0) and a case of non-rotation in FIG. 3), the stepping motor 108 is driven by the correction driving pulse P2 with the same polarity as the main driving pulse P1 in the process of step S503 (step S507). Then, when the rank n of the main driving pulse P1 is not the maximum rank m, the main driving pulse P1 is changed to the main driving pulse P1 (n+1) increased by one rank, and then the process returns to step S601. Then, the main driving pulse P1 (n+1) is used in the subsequent driving (step S508 and step S510).

When the rank n of the main driving pulse P1 is the maximum rank m in the process of step S508, the control circuit 103 changes the main driving pulse P1 to a main driving pulse P1 (n−a) with a predetermined small amount of energy and the process returns to step S601. Then, the main driving pulse P1 (n−a) is used in the subsequent driving (step S509). In this case, since the stepping motor is not rotated even by the driving pulse P1m with the maximum energy rank m among the main driving pulses P1, it is possible to reduce the waste of the energy when the stepping motor is driven by the main driving pulse P1m with the maximum rank m in the subsequent driving. Further, at this time, to obtain a considerable power-saving effect, the main driving pulse may be changed to the main driving pulse P10 with the minimum energy.

When the control circuit 103 determines that the induction signal VRs exceeding the reference threshold voltage Vcomp is detected within the section T3 in the process of step S506 (in a case of the pattern (x, 0, 1)) and the rank n of the main driving pulse P1 is not the maximum rank m, the main driving pulse P1 is increased by one rank to be changed to a main driving pulse P1 (n+1) and the process returns to step S601. The main driving pulse P1 is used in the subsequent driving (step Sand step S510 and a case in which an increase in load is large in FIG. 3).

In the process of step S511, the control circuit 103 may not change the rank when the rank n of the main driving pulse P1 is the maximum rank m. Therefore, the main driving pulse P1 is not changed and the process returns to step S601. The main driving pulse P1 is used in the subsequent driving (step S513).

When the control circuit 103 determines that the induction signal VRs exceeding the reference threshold voltage Vcomp is detected within the section T1 in the process of step S504 (a case of the pattern (1, x, x)), the control circuit 103 determines whether the induction signal VRs exceeding the reference threshold voltage Vcomp is detected within the section T2 in the same way (step S512).

When the control circuit 103 determines that the induction signal VRs exceeding the reference threshold voltage Vcomp is not detected within the section T2 in the process of step S512 (a case of the pattern (1, 0, x)), the process proceeds to step S506 to perform the above-described processes.

When the control circuit 103 determines that the induction signal VRs exceeding the reference threshold voltage Vcomp is detected within the section T2 in the process of step S512 (a case of the pattern (1, 1, x)), the process proceeds to step S513.

When the control circuit 103 determines that the induction signal VRs exceeding the reference threshold voltage Vcomp is detected within the section T2 in the process of step S505 (a case of the pattern (0, 1, x)), the control circuit 103 does not change the rank but maintains the rank due to the fact that the control circuit 103 may not lower the rank when the rank n of the main driving pulse P1 is the minimum rank 0, and then the process returns to step S601 (step S514 and step S518).

When the control circuit 103 determines that the rank n of the main driving pulse P1 is not the minimum rank 0 in the process of step S514, one is added to the continuous driving number of times N (step S515). Then, the control circuit 103 determines whether the continuous driving number of times N is a predetermined number of times (in this embodiment, 160 times) (step S516). When the continuous driving number of times N is not the predetermined number of times, the rank of the main driving pulse P1 is not changed and the process returns to step S601 (step S518). Conversely, when the continuous driving number of times N is the predetermined number of times, the rank of the main driving pulse P1 decreases by one rank, the continuous driving number of times N is reset to 0, and then the process returns to step S601 (step S517).

Thus, when the voltage of the secondary cell 113 is lowered to the voltage equal to or less than the switch voltage, the driving control is performed in the second mode in which the pulse increases when the stepping motor is driven by the maximum energy of the main driving pulse P1, and thus the rotatable driving can be reliably performed.

When the secondary cell 113 is charged by the solar cell 114 during the repetition of the operation of the above-described second mode and the voltage of the secondary cell 113 thus exceeds the switch voltage, the determination in the process of step S601 is “No” and thus the control mode is changed to the first mode.

As described above, the stepping motor control circuit according to the first embodiment of the invention includes: the secondary cell 113 that serves as a power supply that supplies power at least to the stepping motor 108; the voltage detection circuit 112 that detects the voltage of the secondary cell 113; the rotation detection unit for detecting the rotation state of the stepping motor 108; and the control unit for driving the stepping motor 108 in the first mode in which the driving pulse is selected between one kind of main driving pulse P1 and the correction driving pulse P2 with the energy greater than the one kind of main driving pulse 21 in accordance with the rotation state of the stepping motor 108 and the stepping motor 108 is driven or the second mode in which the driving pulse is selected among the plural kinds of main driving pulses P1 and the correction driving pulse P2 with the energy greater than the plural kinds of main driving pulses P1 in accordance with the rotation state of the stepping motor 108 and the stepping motor 108 is driven. The control unit switches a mode between the first and second modes depending on whether the voltage of the secondary cell 113 detected by the voltage detection circuit 112 exceeds the predetermined switch voltage and drives the stepping motor.

Accordingly, the stepping motor is driven in the first mode in which the driving is performed by the one kind of main driving pulse P1, until the voltage of the secondary cell 113 is lowered to the voltage equal to or less than the switch voltage. Therefore, since it is possible to prevent the main driving pulse from being pulse-increased unnecessarily, the energy consumption can be suppressed. Further, since the stepping motor 108 can be driven by the main driving pulse in accordance with the rotation state of the stepping motor 108, the non-rotation can be prevented.

The analog electronic timepiece according to the first embodiment of the invention includes the stepping motor 108 that rotatably drives a time pointer and the stepping motor control circuit that controls the stepping motor 108. The above-described stepping motor control circuit serves as the stepping motor control circuit. Therefore, since the stepping motor 108 is driven by the main driving pulse P1 in accordance with the voltage of the secondary cell 113 and the rotation state of the stepping motor 108, the non-rotation can be prevented. Further, since the energy consumption is suppressed, it is possible to obtain the advantage of performing accurate pointer movement.

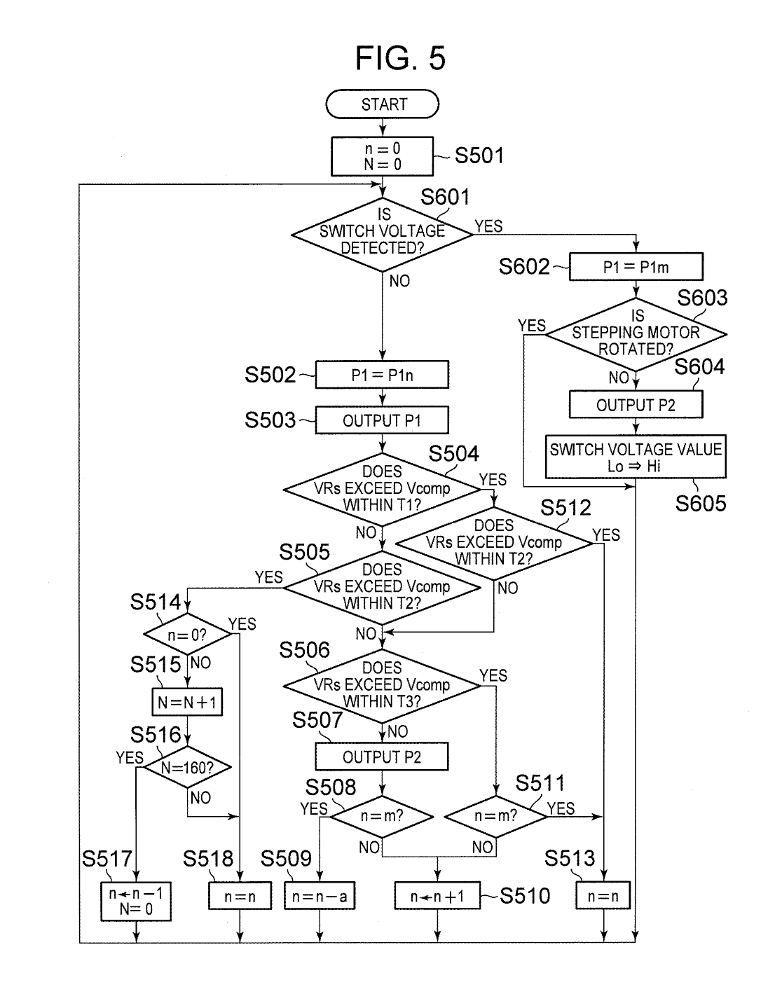

FIG. 5 is a flowchart illustrating the operations of a stepping motor control circuit and an analog electronic timepiece according to a second embodiment of the invention. The same reference numerals are given to units performing the same process in FIG. 4. The block diagram and the pulse control operation in the second embodiment are the same as those in FIGS. 1 to 3.

In the second embodiment, the control mode is switched depending on whether the voltage of the secondary cell 113 exceeds the switch voltage, as in the above-described first embodiment.

In the first embodiment, the first mode operates when the voltage of the secondary cell 113 exceeds the switch voltage, whereas the second mode operates when the voltage of the secondary cell 113 is lowered to the voltage equal to or less than the switch voltage. However, the second embodiment is different from the first embodiment in that the second mode operates when the voltage of the secondary cell 113 exceeds the switch voltage, whereas the first mode operates when the voltage of the secondary cell 113 is lowered to the voltage equal to or less than the switch voltage.

That is, when the control circuit 103 determines that the voltage of the secondary cell 113 exceeds the switch voltage (in the initial setting, the first reference voltage Lo) and is not lowered to the switch voltage in the process of step S601 in FIG. 5, the stepping motor is driven in the second mode. In the second mode, the above mentioned process of step S502 and the subsequent processes are performed. Conversely, when the control circuit 103 determines that the voltage of the secondary cell 113 is lowered to the voltage equal to or less than the switch voltage in the process of step S5601, the stepping motor is driven in the first mode. In the first mode, the above mentioned process of step S602 and the subsequent processes are performed.

In the stepping motor control circuit according to the second embodiment, the control circuit 103 switches the control mode between the first and second modes depending on whether the voltage of the secondary cell 113 detected by the voltage detection circuit 112 exceeds a predetermined switch voltage and drives the stepping motor 108, as in the above-described first embodiment.

Accordingly, after the voltage of the secondary cell 113 is lowered to the voltage equal to or less than the switch voltage, the stepping motor 108 is driven in the first mode in which the driving is performed by one kind of main driving pulse P1. Therefore, since it is possible to prevent the main driving pulse P1 from being pulse-increased unnecessarily, the energy consumption can be suppressed.

Before the voltage of the secondary cell 113 is lowered to the voltage equal to or less than the switch voltage, the stepping motor 108 is driven in the second mode in which the driving is performed by the plural kinds of main driving pulses P1. Therefore, since the stepping motor 108 is driven by the main driving pulse P1 in accordance with the rotation state of the stepping motor 108, the non-rotation can be prevented.

The analog electronic timepiece according to the second embodiment of the invention includes the stepping motor 108 that rotatably drives a time pointer and the stepping motor control circuit that controls the stepping motor 108. The above-described stepping motor control circuit serves as the stepping motor control circuit. Therefore, since the stepping motor 108 is driven by the main driving pulse P1 in accordance with the voltage of the secondary cell 113 and the rotation state of the stepping motor 108, the non-rotation can be prevented. Further, since the energy consumption is suppressed, it is possible to obtain the advantage of performing accurate pointer movement.

Next, a third embodiment of the invention will be described. The block diagram of the third embodiment is the same as the block diagram of FIG. 1.

In the first and second embodiments described above, two kinds of modes are provided. That is, the first mode is provided in which the driving is performed using one kind of main driving pulse P1 and the correction driving pulse P2 with the energy greater than the main driving pulse P1. Further, the second mode is provided in which the driving is performed using the plural kinds of main driving pulses P1 different from each other in energy or the correction driving pulse P2 with the energy greater than each main driving pulse P1. In the third embodiment, however, a third mode is further provided.

In the above-described first embodiment, the second mode operates when the voltage of the secondary cell 113 is lowered up to the predetermined voltage, whereas the first mode operates when the voltage of the secondary cell 113 exceeds the predetermined voltage. In the third embodiment, however, the second mode operates when the voltage of the secondary cell 113 is lowered up to the predetermined voltage, whereas the first mode operates when the voltage of the secondary cell 113 exceeds the predetermined voltage. After the rotation state of the stepping motor 108 is changed to a predetermined state during the operation of the first mode, the third mode operates. When the voltage of the secondary cell 113 is lowered up to the predetermined voltage during the operation of the third mode, the control mode is changed to the second mode.

In the second mode which is a mode when the voltage of the secondary cell 113 is equal to or less than the predetermined value, as described above, the stepping motor 108 is driven using the plural kinds of main driving pulses (a first main driving pulse group) different from each other in energy and the correction driving pulse P2 with the energy greater than the first main driving pulse group, and the rotation state is detected using the first detection section divided into three sections.

On the other hand, in the first mode which is a mode when the voltage of the secondary cell 113 exceeds the predetermined value, the stepping motor 108 is driven using one kind of main driving pulse P1 and the correction driving pulse P2 with the energy greater than the main driving pulse P1, and the rotation state is detected using the second detection section divided into four sections. The time duration of the first detection section is the same as that of the second detection section.

When the rotation state of the stepping motor 108 becomes a predetermined state during the driving of the first mode, the control mode is changed from the first mode to the third mode, in which the driving is performed using plural kinds of main driving pulses P1 (a second main driving pulse group) different from each other in energy and lower in energy than the first main driving pulse group and the correction driving pulse P2 with energy greater than each main driving pulse P1, and the stepping motor 108 is driven. The third mode is a mode when the voltage of the secondary cell 113 exceeds the predetermined value. In the third mode, the rotation state is detected using the second detection section divided into four sections, as in the first mode.

The driving pulses with various energies can be used as the main driving pulse P1 used in the first mode. In the third embodiment, the main driving pulse with the maximum energy in the second main driving pulse group is used as the main driving pulse P1 used in the first mode. In the first mode, when it is determined that the driving energy is large and the pulse-decreases is necessary, the control mode is changed to the third mode in which the driving is performed using the second main driving pulse group.

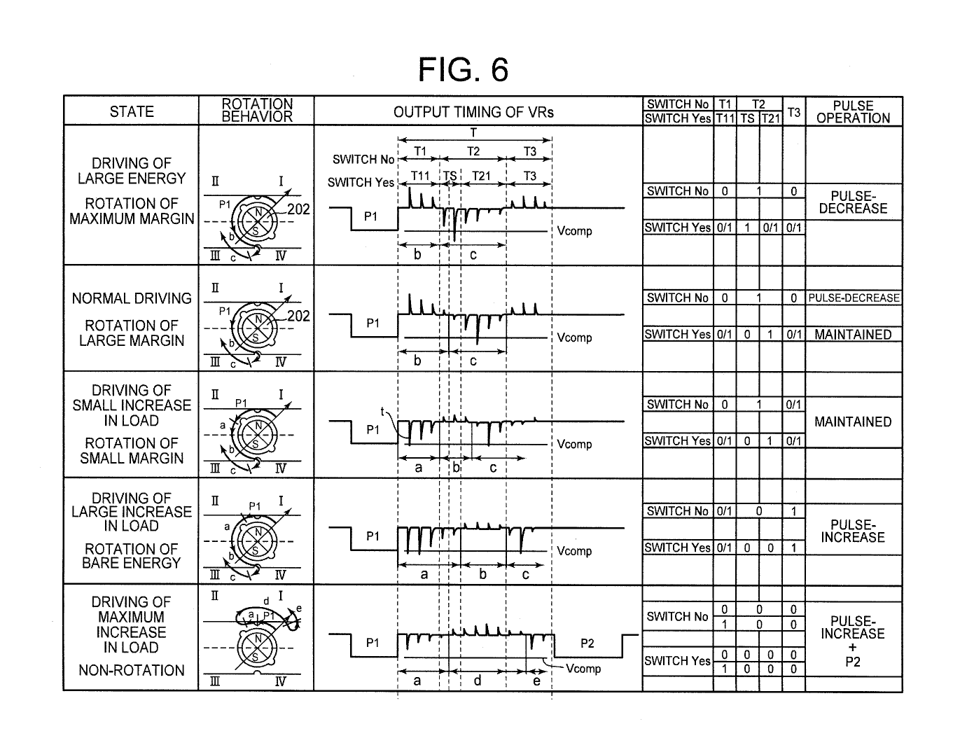

FIG. 6 is a diagram illustrating timings when the stepping motor 108 is driven by the main driving pulse P1 in the third mode according to the third embodiment of the invention.

In the third mode, the detection section T immediately after the driving of the main driving pulse 21 is divided into a fourth section T11, a fifth section TS which is a predetermined time after the fourth section T11, a sixth section T21 which is a predetermined time after the fifth section TS, and a seventh section T3 which is a predetermined time after the sixth section T21.

The fourth section T11 and the seventh section T3 correspond to the first section T1 and the third section T3 shown in FIG. 2. In the third embodiment, the second section T2 shown in FIG. 2 is divided (for example, equally divided) into the fifth section TS and the sixth section T21. The fifth section TS corresponds to the front region section of the second section T2 and the sixth section T21 corresponds to the rear region section of the second section T2. When a state where the induction signal VRs exceeding the reference threshold voltage Vcomp is generated in the sixth section T21 is changed to a state where there is a margin of the driving energy, a change occurs so that the induction signal VRs is quickly generated. Therefore, the change occurs so that the induction signal VRs is generated not in the sixth section T21 but in the fifth section TS. Thus, the change in the margin of energy can be determined.

In FIG. 6, the sections (the first section T1 to the third section T3) of the detection section T in the second mode are written together.

Thus, the entire detection section T starting immediately after the driving of the main driving pulse P1 is divided into a plurality of sections (in this embodiment, four sections T4 to T7).

In the third embodiment, a method of dividing the detection section T in the first mode is the same as that in the third mode.

When the XY coordinate space, where the rotor 202 of the stepping motor 108 is a center and a main magnetic pole (the straight arrow in the drawings indicating the rotation behavior in FIG. 6) of the rotor 202 is located by the rotation, is divided into the first quadrant I to the fourth quadrant IV, the fourth section T11 to the seventh section T3 can be expressed as follows.

That is, in a normal driving state (a rotation state where the margin of the driving energy is large), the fourth section T11 is a section in which a forward direction (counterclockwise rotation direction) rotation state of the rotor 202 in the third quadrant III of the space where the rotor 202 is the center is determined, the fifth section TS is a section in which the initial forward direction rotation state and the initial backward direction (clockwise direction) rotation state of the rotor 202 in the third quadrant III are determined, the sixth section T21 is a section in which the initial backward direction rotation state of the rotor 202 in the third quadrant III is determined, and the seventh section T3 is a section in which the rotation state after the initial backward direction rotation of the rotor 202 is determined. Here, the normal driving state is a state where the load driven in the normal time can be driven regularly by the main driving pulse P1. In this embodiment, the normal driving state is a state where the time pointers can be regularly driven as the load by the main driving pulse P1.

In a state (a driving state where an increase in the load is small and a rotation state where the margin of the energy is small) where the driving energy is slightly smaller than the normal driving, the fourth section T11 is a section in which the forward direction rotation state of the rotor 202 in the second quadrant II is determined, the fifth section TS is a section in which the initial forward direction rotation state of the rotor 202 in the third quadrant III is determined, the sixth section T21 is a section in which the initial forward direction rotation state and the initial backward direction rotation state of the rotor 202 in the third quadrant III are determined and the seventh section T3 is a section in which the rotation state after the initial backward direction rotation state of the rotor 202 in the third quadrant III is determined.

In a state (a driving state where the increase in the load is large and a rotation state where the energy is the maximum) where the driving energy is further smaller than the rotation state where the margin of the energy is small, the fourth section T11 is a section in which the forward direction rotation state of the rotor 202 in the second quadrant II is determined, the fifth section TS is a section in which the forward direction rotation state of the rotor 202 in the second quadrant II is determined, the sixth section T21 is a section in which the forward direction rotation state of the rotor 202 in the third quadrant III is determined and the seventh section T3 is a section in which the rotation state after the initial backward direction rotation state of the rotor 202 in the third quadrant III is determined.

In a state (a driving state where the increase in the load is the maximum and a non-rotation state where the energy is not sufficient) where the driving energy is further smaller than the rotation state where the energy is the maximum), the rotor 202 may not be rotated.

In a state (a driving state where the energy is high and a state where the margin of energy is the maximum) where the energy is greater than the normal driving, the fourth section T11 is a section in which the initial forward direction rotation state of the rotor 202 in the third quadrant III is determined, the fifth section TS is a section in which the initial backward direction rotation state of the rotor 202 in the third quadrant III is determined, the sixth section T21 is a section in which the initial backward direction rotation state of the rotor 202 in the third quadrant III is determined and the seventh section T3 is a section in which the rotation state after the initial backward direction rotation state of the rotor 202 in the third quadrant III is determined.

In FIG. 6, for example, in the normal driving state of the stepping motor control circuit according to this embodiment, the induction signal VRs generated in the region b is detected in the fourth section T11 and the fifth section TS and the induction signal VRs generated in the region c is detected in the fifth section TS and the sixth section T21, and the induction signal VRs generated after the region c is detected in the seventh section T3.

On the assumption that a determination value “1” indicates a case where the rotation detection circuit 110 detects the induction signal VRs exceeding the reference threshold voltage Vcomp and a determination value “0” indicates a case where the rotation detection circuit 110 may not detect the induction signal VRs exceeding the reference threshold voltage Vcomp, (0, 0, 1, 0) is obtained as a pattern (a determination value in the fourth section, a determination value in the fifth section, a determination value of the sixth section, and a determination value of the seventh section) indicating the rotation state in the normal driving example of FIG. 6. In this case, the control circuit 103 determines that the margin of the driving energy is large and performs pulse control so that the driving energy is not changed and is maintained.

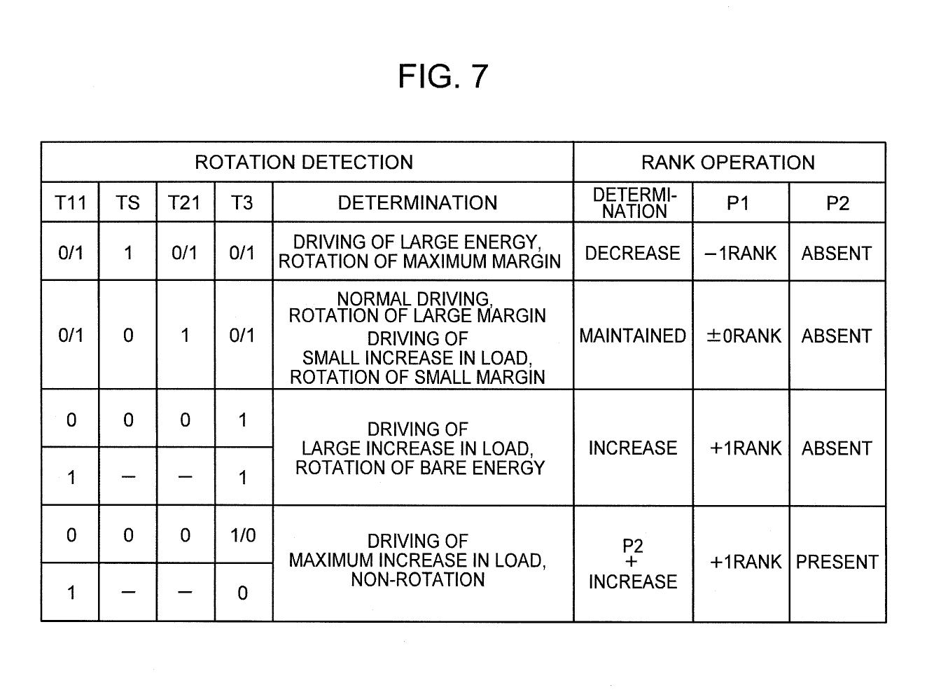

FIG. 7 is a diagram illustrating a common determination chart of the pulse control operations according to the third embodiment of the invention. In FIG. 7, as described above, the determination value “1” indicates the case where the induction signal VRs exceeding the reference threshold voltage Vcomp is detected and the determination value “0” indicates the case where the induction signal VRs exceeding the reference threshold voltage Vcomp may not be detected. Further, a determination value “1/0” indicates any one of the determination values “1” and “0”.

As shown in FIG. 7, the rotation detection circuit 110 detects whether the induction signal VRs exceeding the reference threshold voltage Vcomp is present. The detection section determination circuit 111 determines the pattern of the induction signal VRs indicating a section to which the induction signal VRs belongs. In the first and third modes, the control circuit 103 performs pulse control, such as pulse-increase or pulse-decrease of the main driving pulse P1 or the driving performed by the correction driving pulse P2, described below based on the pattern of the induction signal VRs with reference to the determination chart of FIG. 7 stored in the control circuit 103, and then controls the driving of the steeping motor 108.

In the second mode, the detection section T is divided into three sections of the first section T1 to the third section T3 and the pulse control is performed using the determination chart of FIG. 3.

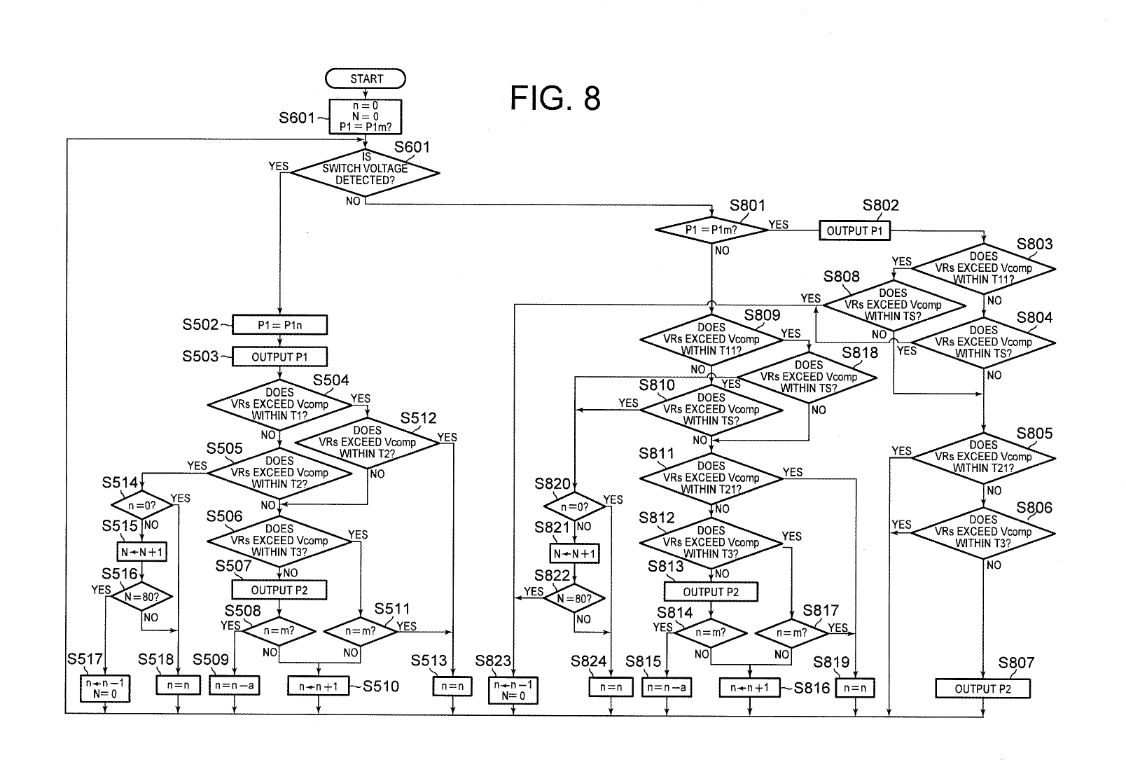

FIG. 8 is a flowchart illustrating the operations of the stepping motor control circuit and the analog electronic timepiece according to the third embodiment of the invention and is a flowchart mainly illustrating an operation of the control circuit 103.

Hereinafter, an operation of the third embodiment of the invention different from the operation of the above-described first embodiment will be described with reference to FIGS. 1 and 6 to 8.

The control circuit 103 resets the rank n of the main driving pulse P1 to 0 (for example, the main driving pulse P10 with the minimum energy in the first main driving pulse group), resets the value of a continuous driving number of times N to 0, and sets the main driving pulse P1m as the main driving pulse P1 (step S501).

Next, the control circuit 103 allows the voltage detection circuit 112 to detect the voltage of the secondary cell 113 and determines whether the voltage detection circuit 112 detects the switch voltage (here, the initially set first reference voltage Lo), that is, whether the voltage of the secondary cell 113 is lowered to the voltage equal to or less than the switch voltage (step S601).

When the control circuit 103 determines that the voltage of the secondary cell 113 is lowered to the switch voltage in the process of step S601, the control circuit 103 performs the driving of the second mode. In the second mode, as described with reference to FIG. 4, the first detection section is divided into three sections and the processes of step S502 to step S518 are repeated using the first main driving pulse group and the correction driving pulse P2, as in the first embodiment.

Conversely, when the control circuit 103 determines that the voltage detection circuit 112 does not detect the switch voltage, that is, that the voltage of the secondary cell 113 exceeds the switch voltage in the process of step S601, the control mode is changed to the operation of the first or third mode, as described below. In the first and third mode, the operation is performed using the second main driving pulse group and the second detection section divided into four sections.

When the control circuit 103 determines that the voltage of the secondary cell 113 exceeds the switch voltage in the process of step S601, the control circuit 103 determines whether the main driving pulse P1 is the main driving pulse P1m with the maximum energy in the second main driving pulse group (step S801).

When the control circuit 103 determines that the main driving pulse P1 is the main driving pulse P1m in the process of step S801, the control circuit 103 outputs a control signal to the main driving pulse generation circuit 104 so that the stepping motor 108 is driven by the main driving pulse P1m (step S802).

The main driving pulse generation circuit 104 outputs the main driving pulse P1m with the energy corresponding to the control signal to the motor driver circuit 107. Then, the motor driver circuit 107 rotatably drives the stepping motor 108 by the main driving pulse P1m.

The rotation detection circuit 110 detects the induction signal VRs exceeding the reference threshold voltage Vcomp among the induction signals VRs generated by the rotation of the stepping motor 108 in the detection section T. The detection section determination circuit 111 determines a section to which the induction signal VRs exceeding the reference threshold voltage Vcomp belongs among the sections T11 to T3.

The control circuit 103 determines whether the detection section determination circuit 111 determines that the detection time t of the induction signal VRs is within the fourth section T11 (that is, whether the induction signal VRs exceeding the reference threshold voltage Vcomp is detected within the fourth section T11) (step S803).

When the control circuit 103 determines that the induction signal VRs exceeding the reference threshold voltage Vcomp is not detected within the section T11 in the process of step S803 (in a case of the pattern (0, x, x, x)), the control circuit 103 determines whether the induction signal VRs exceeding the reference threshold voltage Vcomp is detected within the fifth section TS (step S804).

When the control circuit 103 determines that the induction signal VRs exceeding the reference threshold voltage Vcomp is not detected within the section TS in the process of step S804 (in a case of the pattern (0, 0, x, x)), the control circuit 103 determines whether the induction signal VRs exceeding the reference threshold voltage Vcomp is detected within the sixth section T21 (step S805).

When the control circuit 103 determines that the induction signal VRs exceeding the reference threshold voltage Vcomp is not detected within the sixth section T21 in the process of step S805 (a case of the pattern (0, 0, 0, x)), the control circuit 103 determines whether the induction signal VRs exceeding the reference threshold voltage Vcomp is detected within the section T3 (step S806).

When the control circuit 103 determines that the induction signal VRs exceeding the reference threshold voltage Vcomp is not detected within the section T3 in the process of step S806 (in a case of the pattern (0, 0, 0, 0)), the control circuit 103 determines that the stepping motor 108 is not rotated and outputs a control signal to the correction driving pulse generation circuit 105 so that the stepping motor 108 is driven by the correction driving pulse P2 (step S807). Then, the process returns to step S601.

In response to the control signal, the correction driving pulse generation circuit 105 outputs the correction driving pulse P2 to the motor driver circuit 107. The motor driver circuit 107 rotatably drives the stepping motor 108 forcibly by the correction driving pulse P2.

Conversely, when the control circuit 103 determines that the induction signal VRs exceeding the reference threshold voltage Vcomp is detected within the section T3 in the process of step S806 (in a case of the pattern (0, 0, 0, 1)) and determines that the induction signal VRs exceeding the reference threshold voltage Vcomp is detected within the section T21 in the process of step S805 (in a case of the pattern (0, 0, 1, x)), the process immediately returns to step S601.

When the control circuit 103 determines that the induction signal VRs exceeding the reference threshold voltage Vcomp is detected within the section TS in the process of step S804 (in a case of the pattern (0, 1, x, x)), the control circuit 103 changes the main driving pulse P1m with the maximum energy rank to a main driving pulse P1 (m−1) by lowering the energy rank of the main driving pulse P1m by one rank (step S823), and then the process returns to step S601.

When the control circuit 103 determines that the induction signal VRs exceeding the reference threshold voltage Vcomp is detected within the section T11 in the process of step S803 (in a case of the pattern (1, x, x, x)), and determines that the induction signal VRs exceeding the reference threshold voltage Vcomp is not detected within the section TS (in a case of the pattern (1, 0 x, x)), the process proceeds to step S805. When the control circuit 103 determines that the induction signal VRs exceeding the reference threshold voltage Vcomp is detected within the section TS (in a case of the pattern (1, 1, x, x)), the process proceeds to step S823. The control circuit 103 lowers the energy rank of the main driving pulse P1m by one rank, and then the process returns to step S601.

When the voltage of the secondary cell 113 exceeds the switch voltage and the fifth section TS is in the state of “0” through the above-described processes, the driving of the first mode continues using the second detection section, the main driving pulse P1m, and the correction driving pulse P2.

Conversely, when the fifth section TS is “1” in the process of step S804 or the process of step S808, the control 103 changes the main driving pulse P1m to the main driving pulse P1 (m−1) by lowering the energy rank of the main driving pulse P1m by one rank in the process of step S823, and the voltage of the secondary cell 113 continuously exceeds the switch voltage (step S601), the control mode is changed to the third mode from the process of step S801 to drive the stepping motor.

That is, when the fifth section TS is “1” in the process of step S804 or the process of step S808 and the voltage of the secondary cell 113 exceeds the switch voltage, the control circuit 103 determines that the main driving pulse P1 is not the main driving pulse P1m in the process of step S801 and outputs a control signal to the main driving pulse generation circuit 104 so that the stepping motor 108 is driven by the main driving pulse P1 (here, the main driving pulse P1 (m−1)) at that time.

The main driving pulse generation circuit 104 outputs the main driving pulse P1 with the energy corresponding to the control signal to the motor driver circuit 107. The motor driver circuit 107 rotatably drives the stepping motor 108 by the main driving pulse P1.

The rotation detection circuit 110 detects the induction signal VRs exceeding the reference threshold voltage Vcomp among the induction signals VRs generated by the rotation of the stepping motor 108 in the detection section T. The detection section determination circuit 111 determines a section to which the induction signal VRs exceeding the reference threshold voltage Vcomp belongs among the sections T11 to T3.

The control circuit 103 determines whether the detection section determination circuit 111 determines that the detection time t of the induction signal VRs is within the fourth section T11 (that is, whether the induction signal VRs exceeding the reference threshold voltage Vcomp is detected within the fourth section T11) (step S809).

When the control circuit 103 determines that the induction signal VRs exceeding the reference threshold voltage Vcomp is not detected within the section T11 in the process of step S809 (a case of the pattern (0, x, x, x)), the control circuit 103 determines whether the induction signal VRs exceeding the reference threshold voltage Vcomp is detected within the section TS in the same way (step S810).

When the control circuit 103 determines that the induction signal VRs exceeding the reference threshold voltage Vcomp is not detected within the section TS in the process of step S810 (a case of the pattern (0, 0, x, x)), the control circuit 103 determines whether the induction signal VRs exceeding the reference threshold voltage Vcomp is detected within the section T21 in the same way (step S811).

When the control circuit 103 determines that the induction signal VRs exceeding the reference threshold voltage Vcomp is not detected within the section T21 in the process of step S811 (a case of the pattern (x, 0, 0, x)), the control circuit 103 determines whether the induction signal VRs exceeding the reference threshold voltage Vcomp is detected within the section T3 in the same way (step S812).

When the control circuit 103 determines that the induction signal VRs exceeding the reference threshold voltage Vcomp is not detected within the section T3 in the process of step S812 (a case of the pattern (x, 0, 0, 0) and a case of non-rotation in FIG. 7), the stepping motor 108 is driven by the correction driving pulse P2 (step S813). When the rank n of the main driving pulse P1 is not the maximum rank m, the energy rank of the main driving pulse P1 increases by one rank, and then the process returns to step S601. Then, the main driving pulse P1 is used in the subsequent driving (step S814 and step S816).

When the rank n of the main driving pulse P1 is the maximum rank m in step S814, the control circuit 103 changes the main driving pulse P1 to the main driving pulse P1 (n−a) with a predetermined small amount of energy, and then the process returns to step S601. The main driving pulse P1 (n−a) is used in the subsequent driving (step S815). In this case, since the stepping motor is not rotated even by the driving pulse P1m with the maximum energy rank m among the main driving pulses P1, it is possible to reduce the waste of the energy when the stepping motor is driven by the main driving pulse P1m with the maximum energy rank m in the subsequent driving. Further, at this time, to obtain a considerable power-saving effect, the main driving pulse may be changed to the main driving pulse P1 with the minimum energy in the second main driving pulse group.

When the control circuit 103 determines that the induction signal VRs exceeding the reference threshold voltage Vcomp is detected within the section T3 in the process of step S812 (in a case of the pattern (x, 0, 0, 1) and a case in which an increase in load is large in FIG. 7) and the rank n of the main driving pulse P1 is not the maximum rank m, the main driving pulse P1 increased by one rank to be changed to a main driving pulse 21 (n+1) and the process returns to step S601. The main driving pulse P1 is used in the subsequent driving (step S817 and step S816).

In the process of step S817, the control circuit 103 may not change the rank when the rank n of the main driving pulse P1 is the maximum rank m. Therefore, the main driving pulse P1 is not changed and the process returns to step S601. The main driving pulse P1 is used in the subsequent driving (step S819).

When the control circuit 103 determines that the induction signal VRs exceeding the reference threshold voltage Vcomp is detected within the section T21 in the process of step S811 (a case of the pattern (x, 0, 1, x)), the process proceeds to step S819.

When the control circuit 103 determines that the induction signal VRs exceeding the reference threshold voltage Vcomp is detected within the section TS in the process of step S810 (a case of the pattern (0, 1, x, x)), the process proceeds to step S820.

When the control circuit 103 determines that the induction signal VRs exceeding the reference threshold voltage Vcomp is detected within the section T11 in the process of step S809 (a case of the pattern (1, x, x, x)), the control circuit 103 determines whether the induction signal VRs exceeding the reference threshold voltage Vcomp is detected within the section TS (step S818).

When the control circuit 103 determines that the induction signal VRs exceeding the reference threshold voltage Vcomp is not detected within the section TS in the process of step S818 (a case of the pattern (1, 0, x, x)), the process proceeds to step S811 and the above-described process is performed.

When the control circuit 103 determines that the induction signal VRs exceeding the reference threshold voltage Vcomp is detected within the section TS in the process of step S818 (a case of the pattern (1, 1, x, x)), the process proceeds to step S820.

The control circuit 103 may not lower the rank when the rank n of the main driving pulse. P1 is the minimum rank 0 in step S820. Therefore, the control circuit 103 does not change the rank but maintains the rank, the process returns to step S601 (step S824).

When the control circuit 103 determines that the rank n of the main driving pulse P1 is not the minimum rank 0 in the process of step S820, one is added to the continuous driving number of times N (step S821). Then, the control circuit 103 determines whether the continuous driving number of times N is a predetermined number of times (in this embodiment, 80 times) (step S822). When the continuous driving number of times N is not the predetermined number of times, the rank of the main driving pulse P1 is not changed and the process returns to step S601 (step S824). Conversely, when the continuous driving number of times N is the predetermined number of times, the rank of the main driving pulse P1 decreases by one rank, the continuous driving number of times N is reset to 0, and then the process returns to step S601 (step S823).

The stepping motor control circuit according to the third embodiment provides not only the first and second modes but also the third mode in which the driving pulse is selected among the plural kinds of main driving pulses P1 (the second main driving pulse group) with the energy less than the main driving pulses P1 (the first main driving pulse group) of the second mode and the correction driving pulse P2 with the energy greater than the plural kinds of main driving pulses P1 in accordance with the rotation state of the stepping motor 108 and the stepping motor 108 is driven. The control unit maintains the driving state of the first mode when the rotation state of the stepping motor driven by the main driving pulse P1 of the first mode indicates pulse-maintenance or pulse-increase, whereas the control unit switches the mode to the third mode and drives the stepping motor when the rotation state of the stepping motor driven by the main driving pulse of the first mode indicates pulse-decrease.

In the second mode, the detection section in which the rotation state of the stepping motor 108 is detected is the first detection section divided into a first section T1 immediately after the driving of the main driving pulse P1, the second section after the first section, and the third section after the second section. In the normal driving state, the first section is a section in which the forward direction rotation state of the rotor 202 in the third quadrant of the space where the rotor 202 is a center is determined, the second section is a section in which the initial forward direction rotation state and the initial backward direction rotation state of the rotor 202 in the third quadrant are determined, and the third section is a section in which the rotation state after initial backward direction rotation of the rotor 202 in the third quadrant is determined. In the first and third modes, the detection section is the second detection section divided into the fourth section T11 corresponding to the first section T1, the fifth section TS corresponding to the front region of the second section T2, and the sixth section T21 corresponding to the rear region of the second section T2, and the seventh section T3 corresponding to the third section T3. The control unit switches the mode to the third mode and drives the stepping motor when the control unit drives the stepping motor by the main driving pulse in the first mode and the induction signal exceeding the reference threshold voltage is detected in the fifth section.

The control unit continues the driving of the first mode, when the control unit drives the stepping motor by the main driving pulse in the first mode and the induction signal exceeding the reference threshold voltage is not detected in the fifth section TS.

The main driving pulse used in the first mode is one (for example, the main driving pulse with the maximum energy among the plural kinds of main driving pulses) of the plural kinds of main driving pulses used in the driving of the third mode.

The control unit switches to the second mode and drives the stepping motor, when it is detected that the voltage of the secondary cell 113 detected by the voltage detection circuit 112 is equal to or less than the predetermined switch voltage during the driving of the third mode.

Accordingly, in the third embodiment, since the stepping motor is driven by the main driving pulse in accordance with the voltage of the secondary cell and the rotation state of the stepping motor, the non-rotation can be prevented. Further, it is possible to obtain the advantage of suppressing the energy consumption.

When the voltage of the secondary cell 113 is lowered to the voltage equal to or less than the switch voltage, the operation of the second mode is performed. When the voltage of the secondary cell 113 exceeds the switch voltage, the control mode is changed to the first mode and the stepping motor is driven. When the rotation becomes faster (where the fifth section TS is “1”), it is determined that the voltage further increases, and thus the operation of the third mode is performed. Thus, the rotation state can be accurately determined. Further, since the main driving pulse can be switched to the main driving pulse with appropriate energy to drive the stepping motor, the power can be saved.

In the analog electronic timepiece according to the third embodiment, since the stepping motor is driven by the main driving pulse in accordance with the voltage of the secondary cell and the rotation state of the stepping motor, the non-rotation can be prevented. Further, since the energy consumption is suppressed, it is possible to obtain the advantage of performing accurate pointer movement.

In each embodiment described above, the solar cell 114 is included in the analog electronic timepiece as a charging unit for the secondary cell 113. However, a charging unit, such as an automatic winding charging unit or a manual winding charging unit, other than the solar cell 114 may be used and the charging unit may be separate from the analog electronic timepiece.

Further, the stepping motor described above is applicable to a stepping motor that drives other than time pointers or a calendar.

An electronic timepiece has been explained as an example of an application example of the stepping motor, but the stepping motor is applicable to an electronic apparatus using a motor.

The stepping motor control circuit according to the invention is applicable to various electronic apparatuses using a stepping motor.

Further, the electronic timepiece according to the invention is applicable to various analog electronic timepieces such as an analog electronic timepiece, which has a calendar function, such as an analog electronic wristwatch having a calendar function, and an analog electronic clock having a calendar function.

What is claimed is:

1. A stepping motor control circuit comprising:
a secondary cell serving as a power supply that supplies power at least to a stepping motor;
a voltage detection unit detecting a voltage of the secondary cell;
a rotation detection unit detecting a rotation state of the stepping motor; and
a control unit driving the stepping motor in a first mode in which a driving pulse is selected between one kind of main driving pulse and a correction driving pulse with energy greater than the one kind of main driving pulse in accordance with a rotation state of the stepping motor and the stepping motor is driven or a second mode in which the driving pulse is selected among plural kinds of main driving pulses and a correction driving pulse with energy greater than the plural kinds of main driving pulses in accordance with the rotation state of the stepping motor and the stepping motor is driven,
wherein the control unit switches a mode between the first and second modes depending on whether the voltage of the secondary cell detected by the voltage detection unit exceeds a predetermined switch voltage and drives the stepping motor.

2. The stepping motor control circuit according to claim 1, wherein when the rotation detection unit detects that the stepping motor is not rotated during the driving of the first mode, the control unit switches the switch voltage to a higher voltage.

3. The stepping motor control circuit according to claim 1, wherein when the rotation detection unit detects that the stepping motor is able to be rotated during the driving of the second mode but there is no margin of energy, the control unit pulse-increases the main driving pulse.

4. The stepping motor control circuit according to claim 2, wherein when the rotation detection unit detects that the stepping motor is able to be rotated during the driving of the second mode but there is no margin of energy, the control unit pulse-increases the main driving pulse.

5. The stepping motor control circuit according to claim 1, wherein the main driving pulse used in the first mode is a main driving pulse with a maximum energy among the main driving pulses used in the second mode.

6. The stepping motor control circuit according to claim 2, wherein the main driving pulse used in the first mode is a main driving pulse with a maximum energy among the main driving pulses used in the second mode.

7. The stepping motor control circuit according to claim 3, wherein the main driving pulse used in the first mode is a main driving pulse with a maximum energy among the main driving pulses used in the second mode.

8. The stepping motor control circuit according to claim 4, wherein the main driving pulse used in the first mode is a main driving pulse with a maximum energy among the main driving pulses used in the second mode.

9. The stepping motor control circuit according to claim 1,
wherein a third mode is further provided in which a driving pulse is selected among plural kinds of main driving pulses with energy less than the main driving pulses of the second mode and a correction driving pulse with energy greater than the plural kinds of main driving pulses in accordance with the rotation state of the stepping motor and the stepping motor is driven, and
wherein the control unit maintains the driving state of the first mode when the rotation state of the stepping motor driven by the main driving pulse of the first mode indicates pulse-maintenance or pulse-increase, whereas the control unit switches the mode to the third mode and drives the stepping motor when the rotation state of the stepping motor driven by the main driving pulse of the first mode indicates pulse-decrease.

10. The stepping motor control circuit according to claim 2,
wherein a third mode is further provided in which a driving pulse is selected among plural kinds of main driving pulses with energy less than the main driving pulses of the second mode and a correction driving pulse with energy greater than the plural kinds of main driving pulses in accordance with the rotation state of the stepping motor and the stepping motor is driven, and
wherein the control unit maintains the driving state of the first mode when the rotation state of the stepping motor driven by the main driving pulse of the first mode indicates pulse-maintenance or pulse-increase, whereas the control unit switches the mode to the third mode and drives the stepping motor when the rotation state of the stepping motor driven by the main driving pulse of the first mode indicates pulse-decrease.

11. The stepping motor control circuit according to claim 3,
wherein a third mode is further provided in which a driving pulse is selected among plural kinds of main driving pulses with energy less than the main driving pulses of the second mode and a correction driving pulse with energy greater than the plural kinds of main driving pulses in accordance with the rotation state of the stepping motor and the stepping motor is driven, and
wherein the control unit maintains the driving state of the first mode when the rotation state of the stepping motor driven by the main driving pulse of the first mode indicates pulse-maintenance or pulse-increase, whereas the control unit switches the mode to the third mode and drives the stepping motor when the rotation state of the stepping motor driven by the main driving pulse of the first mode indicates pulse-decrease.

12. The stepping motor control circuit according to claim 4,
wherein a third mode is further provided in which a driving pulse is selected among plural kinds of main driving pulses with energy less than the main driving pulses of the second mode and a correction driving pulse with energy greater than the plural kinds of main driving pulses in accordance with the rotation state of the stepping motor and the stepping motor is driven, and
wherein the control unit maintains the driving state of the first mode when the rotation state of the stepping motor driven by the main driving pulse of the first mode indicates pulse-maintenance or pulse-increase, whereas the control unit switches the mode to the third mode and drives the stepping motor when the rotation state of the stepping motor driven by the main driving pulse of the first mode indicates pulse-decrease.

13. The stepping motor control circuit according to claim 9,
wherein in the second mode, a detection section in which the rotation state of the stepping motor is detected is a first detection section divided into a first section immediately after the driving of the main driving pulse, a second section after the first section, and a third section after the second section,
wherein in a normal driving state, the first section is a section in which a forward direction rotation state of a rotor in a third quadrant of a space where the rotor is a center is determined, the second section is a section in which an initial forward direction rotation state and an initial backward direction rotation state of the rotor in the third quadrant are determined, and the third section is a section in which a rotation state after initial backward direction rotation of the rotor in the third quadrant is determined,
wherein in the first and third modes, the detection section is a second detection section divided into a fourth section corresponding to the first section, a fifth section corresponding to a front region of the second section, a sixth section corresponding to a rear region of the second section, and a seventh section corresponding to the third section, and
wherein the control unit switches the mode to the third mode and drives the stepping motor when the control unit drives the stepping motor by the main driving pulse in the first mode and an induction signal exceeding a reference threshold voltage is detected in the fifth section.

14. The stepping motor control circuit according to claim 10,
wherein in the second mode, a detection section in which the rotation state of the stepping motor is detected is a first detection section divided into a first section immediately after the driving of the main driving pulse, a second section after the first section, and a third section after the second section,
wherein in a normal driving state, the first section is a section in which a forward direction rotation state of a rotor in a third quadrant of a space where the rotor is a center is determined, the second section is a section in which an initial forward direction rotation state and an initial backward direction rotation state of the rotor in the third quadrant are determined, and the third section is a section in which a rotation state after initial backward direction rotation of the rotor in the third quadrant is determined,
wherein in the first and third modes, the detection section is a second detection section divided into a fourth section corresponding to the first section, a fifth section corresponding to a front region of the second section, a sixth section corresponding to a rear region of the second section, and a seventh section corresponding to the third section, and
wherein the control unit switches the mode to the third mode and drives the stepping motor when the control unit drives the stepping motor by the main driving pulse in the first mode and an induction signal exceeding a reference threshold voltage is detected in the fifth section.

15. The stepping motor control circuit according to claim 11,
wherein in the second mode, a detection section in which the rotation state of the stepping motor is detected is a first detection section divided into a first section immediately after the driving of the main driving pulse, a second section after the first section, and a third section after the second section,
wherein in a normal driving state, the first section is a section in which a forward direction rotation state of a rotor in a third quadrant of a space where the rotor is a center is determined, the second section is a section in which an initial forward direction rotation state and an initial backward direction rotation state of the rotor in the third quadrant are determined, and the third section is a section in which a rotation state after initial backward direction rotation of the rotor in the third quadrant is determined,
wherein in the first and third modes, the detection section is a second detection section divided into a fourth section corresponding to the first section, a fifth section corresponding to a front region of the second section, a sixth section corresponding to a rear region of the second section, and a seventh section corresponding to the third section, and
wherein the control unit switches the mode to the third mode and drives the stepping motor when the control unit drives the stepping motor by the main driving pulse in the first mode and an induction signal exceeding a reference threshold voltage is detected in the fifth section.

16. The stepping motor control circuit according to claim 12,
wherein in the second mode, a detection section in which the rotation state of the stepping motor is detected is a first detection section divided into a first section immediately after the driving of the main driving pulse, a second section after the first section, and a third section after the second section,
wherein in a normal driving state, the first section is a section in which a forward direction rotation state of a rotor in a third quadrant of a space where the rotor is a center is determined, the second section is a section in which an initial forward direction rotation state and an initial backward direction rotation state of the rotor in the third quadrant are determined, and the third section is a section in which a rotation state after initial backward direction rotation of the rotor in the third quadrant is determined,
wherein in the first and third modes, the detection section is a second detection section divided into a fourth section corresponding to the first section, a fifth section corresponding to a front region of the second section, a sixth section corresponding to a rear region of the second section, and a seventh section corresponding to the third section, and
wherein the control unit switches the mode to the third mode and drives the stepping motor when the control unit drives the stepping motor by the main driving pulse in the first mode and an induction signal exceeding a reference threshold voltage is detected in the fifth section.

17. The stepping motor control circuit according to claim 13, wherein the control unit continues the driving of the first mode, when the control unit drives the stepping motor by the main driving pulse in the first mode and the induction signal exceeding the reference threshold voltage is not detected in the fifth section.

18. The stepping motor control circuit according to claim 9, wherein the main driving pulse used in the first mode is one of the plural kinds of main driving pulses used in the driving of the third mode.

19. The stepping motor control circuit according to claim 9, wherein the control unit switches to the second mode and drives the stepping motor, when it is detected that the voltage of the secondary cell detected by the voltage detection unit is equal to or less than the predetermined switch voltage during the driving of the third mode.

20. An analog electronic timepiece comprising:
a stepping motor rotatably driving a time pointer; and
a control unit controlling the stepping motor,
wherein the stepping motor control circuit according to claim 1 serves as the control unit for controlling the stepping motor.
